(19) United States
(12) Patent Application Publication
(10) Pub. No.: US 2017/0109020 A1
(43) Pub. Date: Apr. 20, 2017

(54) INTERACTIVE PRESENTATION SYSTEM

(71) Applicant: Maestro Presentation Systems, LLC, Littleton, CO (US)

(72) Inventors: Dieter Austin Sliter, Littleton, CO (US); Jeremy Allan Cunningham, Castle Rock, CO (US)

(73) Assignee: Maestro Presentation Systems, LLC, Littleton, CO (US)

(21) Appl. No.: 15/247,559

(22) Filed: Aug. 25, 2016

Related U.S. Application Data
(60) Provisional application No. 62/209,635, filed on Aug. 25, 2015.

(51) Int. Cl. G06F 3/0484; G06F 3/0488; G09G 5/10; G09G 5/14

(52) U.S. Cl. CPC G06F 3/04845; G09G 5/14; G06F 3/04883; G09G 5/10; G09G 2354/00; G09G 2320/0686; G09G 2320/0626

(57) ABSTRACT

Various implementations of a media presentation system are provided. In one implementation, for example, the system includes a display device comprising a display region, a user input device and a control system. The control system is configured to modify a presentation while the display device is in a presentation mode. Methods of controlling media presentation systems are also provided. In one implementation, for example, a method of controlling a media presentation system includes providing a presentation on a display device in a presentation mode of the media presentation system; receiving a user input from a user input device of a media presentation system at a control system; and altering a display in a display region of the display device in response to the user input, wherein the operation of altering the display comprises modifying the display of the presentation while the media presentation system is in the presentation mode.

### BACKGROUND

### Field

The instant invention relates to media presentation systems.

### BRIEF SUMMARY

Various implementations of media presentation systems are provided.

In one particular implementation, for example, a media presentation, such as an interactive presentation system, is provided that is designed to engage the audience rather than simply talking at them. The system provides the ability to have multiple pieces of content on the screen, combined with, in some implementations, an interactive environment supplied by a touch screen right where the content is, and creates an intimate experience. The result is the ability to not just present, but to make an impact on the audience that they will remember. Aspects and behaviors have been designed to give the presenter the ability to conduct a dynamic presentation. Instead of a pre-defined set of content in a rigid order, this system allows the presenter the option to pull up content as needed, and adjust to meet feedback from the audience without ever leaving the workspace. If desired, this system will also work alongside other applications without interrupting the presentation.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 depicts an example media presentation system according to one or more implementations shown and described herein.

FIG. 2 depicts another example media presentation system including a touchscreen display system adapted to receive one or more user input according to one or more implementations shown and described herein.

FIG. 3 depicts an example “cinema” mode of a media presentation system according to one or more implementations shown and described herein.

FIG. 4 depicts an example “blackout” mode of a media presentation system according to one or more implementations shown and described herein.

FIG. 5 depicts an example “collage” mode of a media presentation system according to one or more implementations shown and described herein.

FIG. 6 depicts an example “stage” mode of a media presentation system according to one or more implementations shown and described herein.

FIG. 7 depicts example gestures that may be used to control one or more aspect of a media presentation system.

FIG. 8 depicts a flowchart of example operations of a “focus” annotation tool of a media presentation system according to one or more implementations shown and described herein.

FIG. 9 depicts another flowchart of example operations of receiving user inputs to control movement of one or more media content asset within a presentation of a media presentation system according to one or more implementations shown and described herein.

FIG. 10 depicts yet another flowchart of example operations of receiving user inputs to control a velocity and/or acceleration of one or more media content assets within a presentation of a media presentation system according to one or more implementations shown and described herein.

FIG. 11 depicts a schematic diagram of an example computing device that may be used as part of a media presentation system according to one or more implementations shown and described herein.

### DETAILED DESCRIPTION

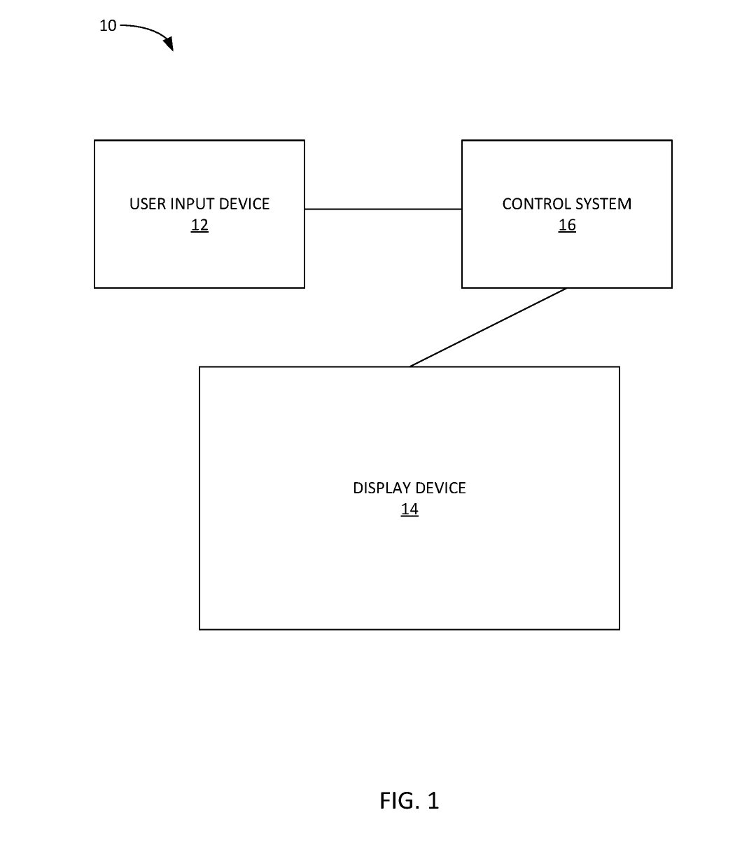

FIG. 1 depicts an example media presentation system 10 according to one or more implementations depicted herein. The media presentation system 10, includes one or more user input devices 12, one or more display devices 14 and a control system 16 adapted to detect one or more user inputs from the user input device(s) 12 and control a display of the display device(s) 14 in response to the one or more user inputs. The media presentation system 10, for example, may include an interactive media presentation system through which a user can interact with the presentation, such as by modifying one or more aspect of a presentation that is operating in a presentation mode.

In various implementations, for example, the user input device(s) may be any type of hardware device that sends data to the controller in response to a user action. A user input device, for example, may include but is not limited to a mouse, keyboard, touchscreen, camera (video or still image camera), pen, stylus, two-or three dimensional motion sensor (e.g., a virtual reality motion sensor, a wrist band, an arm band, a glove, finger pads, wand, or the like), light sensor, composite user input device (e.g., a game controller, gamepad, paddle, jog dial/shuttle, knob, remote controller), etc. The user input device 12, for example, may comprise any type of user input device accessible by any type of computing device, such as but not limited to a personal computer, a laptop computer, a tablet, a smartphone, a server or the like, regardless of operating system. The display device 14 may include any type of display device adapted for presenting information in a visual or tactile form. The display device 14 is adapted to display information under control of the controller 16 in response to a user input detected via the one or more user input devices 12. A display device 16 in the media presentation system 10 as described herein may include but is not limited to a television set (liquid crystal display (LCD), light-emitting diode display (LED), electroluminescent display (ELD), plasma display panel (PDP), liquid crystal display (LCD), organic light emitting diode display (OLED), surface-conduction electron-emitter display (SED), field emission display (FED), laser television, cathode ray tube, a computer monitor, carbon nanotube display, quantum dot display, interferometric modulator display (IMOD), any type of laser/capacitive or touch enable display device, or the like.

In one particular implementation, for example, the media presentation system 10 may be adapted to allow a user to modify a presentation while the media presentation system 10 is in a presentation mode. In this implementation, the user may have initiated a presentation via the user input device. The control system 16, in turn, is adapted to control the presentation via the display device 14. While the media presentation system is actively presenting the presentation, the user may alter the presentation on the fly creating an interactive experience. Depending on the circumstances of the presentation, the user may, for example, select a media element (e.g., a video, audio, document, PDF or any other file type that includes one or more media asset including but not limited to video, audio, static media asset that may be provided via a media presentation system) via the user input device 12 and the control system 16 for the active presentation without having to exit a presentation mode.

The control system 16, for example, may be configured to allow access to one or more files or other data structures resident in memory (e.g., read access memory (RAM), read only memory (ROM), and flash memory), in a data storage element (e.g., on a magnetic disk drive, an optical disk drive, and a USB drive) or otherwise accessible via the control system (e.g., via a database resident on the control system or accessible by the control system 16). The control system 16 may comprise any computing device and/or module, application, firmware or other executable executing on a computing device and may include any operating system, including but not limited to PC, mobile, Windows, DOS, Mac OS, iOS, GNU, UNIX, BSD, Haiku, Linux, Android or the like. The control system 16, for example, may be configured to access the files or other data structures accessible via the control system 16 via a file folder, a file queue or other file access system. Similarly, the control system 16 may be configured to allow the media presentation system 10 the ability to find, copy, cut, paste or otherwise retrieve and insert one or more media files from data storage accessible on or by the control system, within one or more applications (e.g., email). In a window-type environment, for example, the presentation mode of an application may be executing in a first window on the control system. The control system 16 may also be adapted to allow a user to browse images, videos, files or other information using one or more additional windows and copy and paste, drag and drop or otherwise retrieve and insert the information into an active display screen (e.g., presentation mode of a presentation) executing in the first window. Inserting the information into the first window allows a user to add that information into an active presentation during a presentation mode of the media presentation system 10. Similarly, different functions may be embodied in different software or firmware layers or tiers to allow access to one or more files while actively presenting a presentation.

In one particular implementation, the control system 16 for the media presentation system may comprise software operating within one or more windows (or other separable viewing areas or components within an operating system). In this particular implementation, for example, a window or other area including the control system 16 may be resized, moved, switched or otherwise controlled to allow a user to identify, access one or more media assets (e.g., files) through a file folder or other discovery interface and copy, drag and drop, cut or otherwise moved into the control system window of the media presentation system.

The control system 16 may comprise a computing system separate from the display device 14 or may be wholly or partially integrated in a computing system of the display device 14.

In one particular implementation, the media presentation system 10 further includes a queue or other file/data system that stores or otherwise references one or more media files for direct access into an active presentation. A queue, for example, may list one or more media files that are available for inclusion in an active presentation. The queue, for example, may include recent files that have been accessed by a particular user, for a particular presentation, or the like. The queue may also list one or more accessible files that are determined to be relevant to a particular subject, theme or other aspect of a presentation. Similarly, the user may add media files to or remove media files from the queue either in preparation for presenting an interactive presentation in presentation mode. In this way, the queue may include one or more files likely to be of interest during a presentation. These file(s) may then be inserted into an active presentation on the fly without exiting the presentation mode of the media presentation system 10.

In various implementations, the media presentation system 10 may also provide dynamic control of a plurality of different media types via a single interface. The user may control one or more user input device(s), for example, to control a plethora of different media types within a single media presentation system 10. A video and/or audio file may be controlled via a touchscreen or other user input devices to play, pause, stop, fast forward, reverse, jump to a particular scene or time or other portion of the video. The user may further manipulate the presentation of the video or audio file by zooming, shrinking, rotating, annotating, highlighting, varying lighting, contrast, color, frequency (e.g., treble, bass), or other conditions of the video or audio, etc. the video or audio file on the display device of the media presentation system 10. The control system 16 may further be configured to allow a user to similarly control a document, image or other information in an active presentation by zooming, shrinking, jumping (e.g., to a page or passage of a document), annotating, highlighting, varying lighting, contrast, color one or more portions of the document, image or other information.

The control system 16 may further be configured to allow a user to manually or automatically organize and create one or more layouts for a presentation. The media presentation system 10, for example, may be configured to provide a backend builder interface (e.g., directly controllable via a display device 14 (e.g., an interactive touchscreen display device) of the presentation or on a separate device (e.g., laptop using a keyboard and/or mouse or tablet screen (e.g., touchscreen)) to enable a user to configure the presentation for presentation on the display device 14 in preparation for a presentation or during an active presentation. A display device 14, for example, may also be configured to allow a user to modify a presentation (e.g., an active presentation being provided in presentation mode or an inactive presentation) using a touchscreen display device and/or another user input device. For example, one or more layouts may be configured and/or modified via a user input device, such as an interactive (e.g., touchscreen) display device.

The backend builder interface, for example, may be configured to allow a user to modify an active presentation as it is being presented on the display device 14 from a separate interface device or may be configured to allow the user to create or modify another interactive presentation in parallel with an existing presentation being actively presented. For an active presentation, for example, the control system may be configured to allow a user to modify one or more characteristics of the presentation and that modification may instantly appear in the presentation on the display device 14.

The control system may further be adapted to allow a user to provide a virtually unlimited number and/or type of assets on a single presentation screen. The control system may be configured to allow a user to naturally control each asset independently or collectively, such as through one or more gestures as described in more detail below.

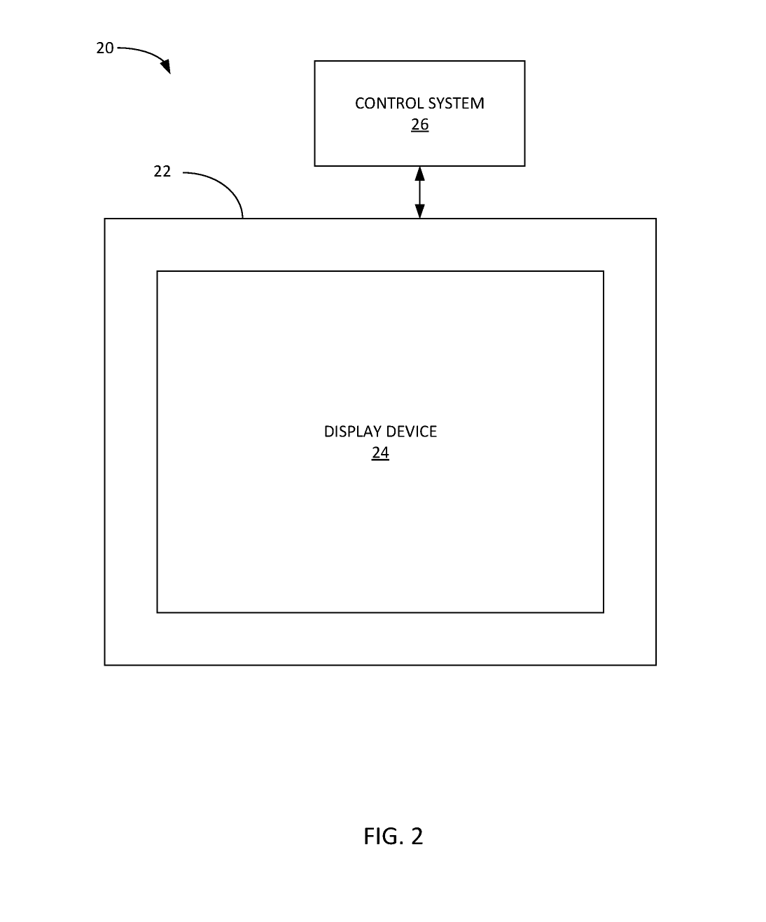

FIG. 2 shows one particular implementation of a media presentation system. In this particular implementation, for example, the media presentation system comprises an interactive presentation system 20 including a touchscreen display system adapted to receive one or more user input at, along or adjacent to a display screen 24 of the touchscreen and display information on the display screen under control of a control system in response to the user input on a display of the touchscreen device. Examples of a touchscreen that may be used in such a system include, without limitation, capacitive touchscreens, resistive touchscreens, infrared touchscreens, laser touchscreen, and the like. The user input device (touch receiver), for example, may be integrated within a display screen of the touchscreen and/or be assembled or otherwise configured with the display screen of the touchscreen system. In one implementation, for example, an infrared (or other sensing) frame 22 may be coupled to the display screen 24 of the touchscreen and adapted to detect user input, such as position and/or motion (e.g., at or along the display screen), and provide information in response to that user input to the control system 26. The control system, in response, is adapted to provide information for display on the display screen of the touchscreen interactive display screen. In one particular implementation, for example, the touchscreen frame may comprise a frame such as a multi-touch screen overlay. One example of such a multi-touch screen overlay is manufactured by PQ Labs, although similar devices are available from a number of other manufacturers as well.

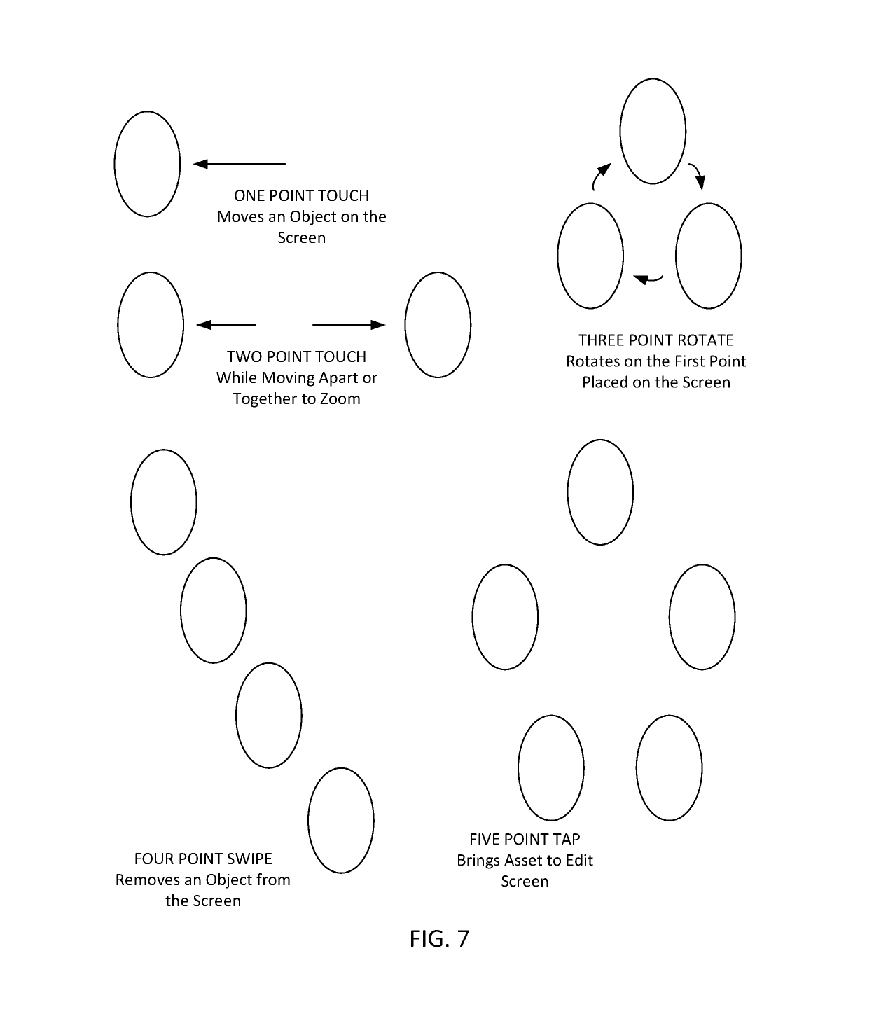

In this implementation, for example, a user may control one or more aspects of a display on the touchscreen display device via one or more hand or finger motions or gestures as shown in FIG. 7. Various finger and hand gestures, for example, may be used to control the display of information on the display screen. In one example, implementation, for example, a one-finger motion is used to move one or more images on the display screen, a two-finger motion is used to scale one or more images on the display screen, a three-finger motion is used to rotate one or more images on the display screen, a four-finger motion is used to remove one or more images from the screen, and a double-tap motion is used to switch between a full screen and center screen display of one or more images on the display screen. These gestures and motions, however, are merely examples and one of ordinary skill in the art, based on this disclosure, could use these or other gestures/motions to perform any number of display features.

In one implementation, the media presentation system 10 includes one or more independently controllable windows. Further, the media presentation system 10 allows a user to share information between the display screen of the media presentation system 10 and other windows under the control of the control system 16. A user, for example, may drag and drop images, videos, files or other information between the active display screen (e.g., presentation mode of a presentation) on the display system of the media presentation system 10 and one or more other windows or interfaces accessible to the control system 16. In this manner, a user may edit a live presentation on-the-fly during a presentation mode by adding, altering and/or deleting content within the presentation while also seeing the presentation in the active presentation mode window. This is in contrast to other presentation systems in which a presentation mode locks out the operating system of the control system 16 from having other active windows and/or sharing content between windows while the display system is in presentation mode. Similarly, the media presentation system 10 allows a user to share content from an active presentation in a presentation mode to a desktop or other window active on the control system 16. In this manner, information created, modified or to be deleted from an active presentation may also be stored and/or shared with another active window operating on the control system 16. Thus, a user may build, modify, annotate and present information for a presentation in a flexible manner.

The media presentation system 10 further provides a user a plurality of modes that may be used within a presentation. In one implementation, for example, the media presentation system provides a user with at least two of the following presentation modes: cinema mode, blackout mode, collage mode, stage mode, presentation mode and save presentation layout mode. These modes are merely examples of modes that may be used in a media presentation system 10 as described herein.

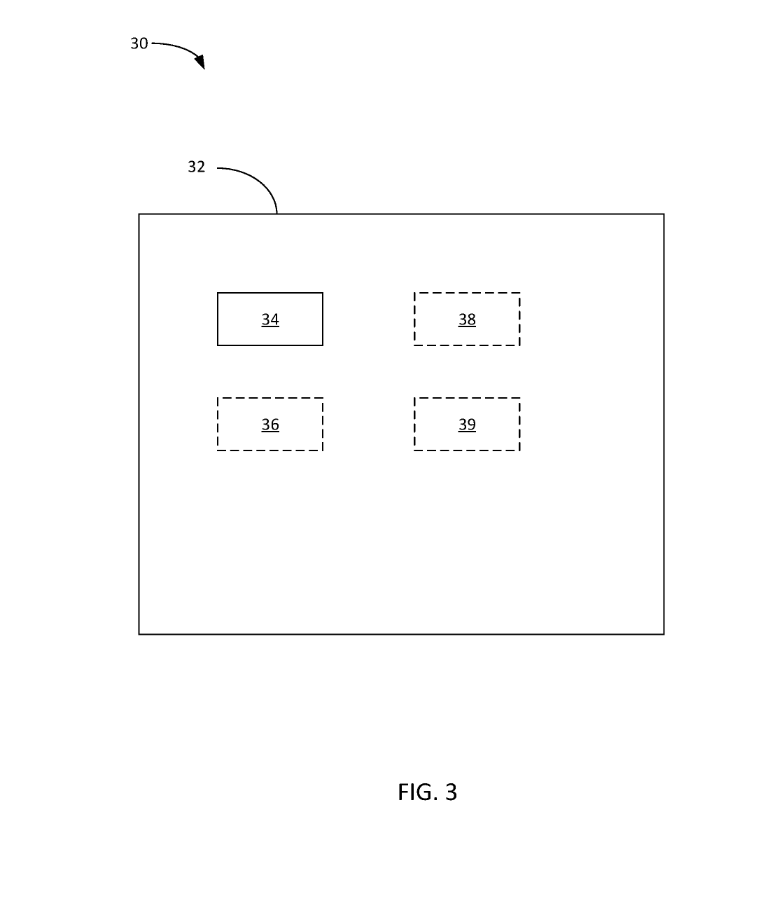

Referring to FIG. 3, in cinema mode 30, for example, one or more active items 34 on a display 32 are presented in a normal or highlighted manner and one or more inactive items 36, 38, 39 are blacked out, grayed out, shown in reduced intensity, reduced in size and/or otherwise de-emphasized with respect to the one or more active items in the display. Similarly, a “spotlight” mode may highlight a single active item (e.g., 34) in contrast to other inactive item(s).

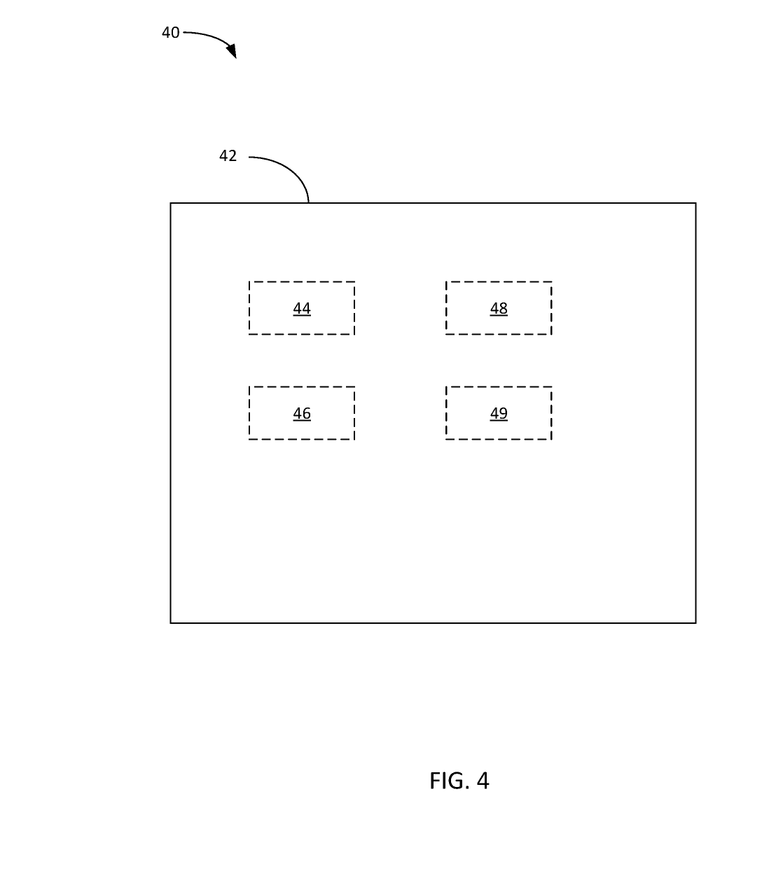

Referring to FIG. 4, in blackout mode 40, all or a portion of the display 42 of a presentation may be blacked out or otherwise obfuscated. A blackout mode, for example, may be used with a presentation during a set up process before it is to be displayed. The blackout mode may also be used during a presentation, e.g., in response to an objection in a court room presentation, while the suitability of a planned presentation is being reviewed. In FIG. 4, for example, each item 34, 36, 38, 39 is blacked out or otherwise obfuscated.

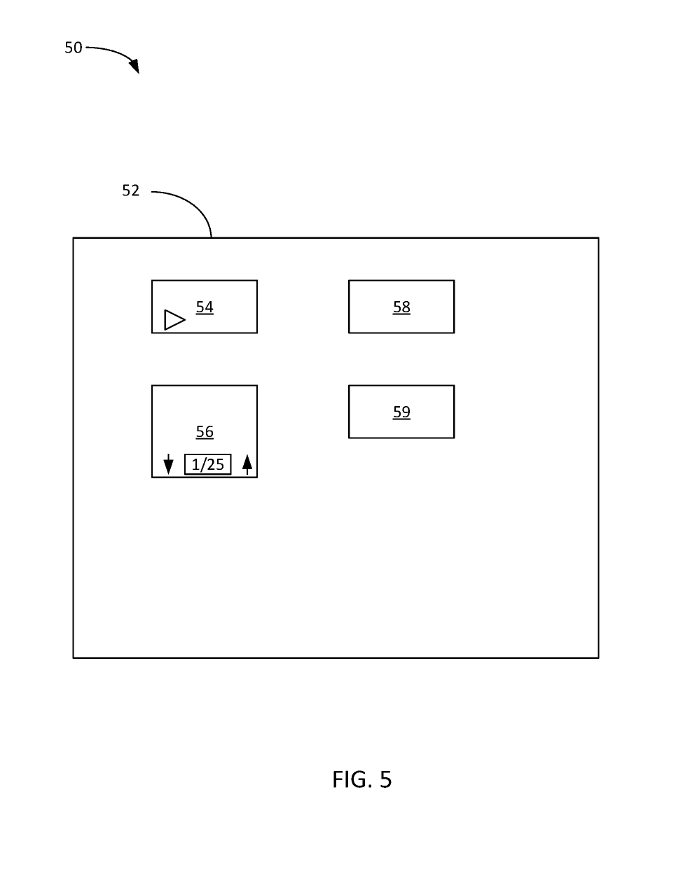

FIG. 5 shows an example of a collage mode 50 that may be used to display multiple content items 54, 56, 58 of a presentation in concert on a display device 52. In one implementation, for example, multiple images, videos, documents (e.g., single or multiple page PDF or other universal document or any other type of document) and the like may be simultaneously displayed by the media presentation system 10 on one or more displays. Many different types or formats of image, video document or other types of files may be used. In addition, the images, videos, documents or other files may be moved, sized, edited or displayed in any number of ways or arrangements. The options are virtually unlimited. In the example shown in FIG. 5, for example, content items 54, 56, 58, 59 include a video file 54, a multiple page document 56 and images 58 and 59. This is merely an example, however, and any number of display combinations is possible.

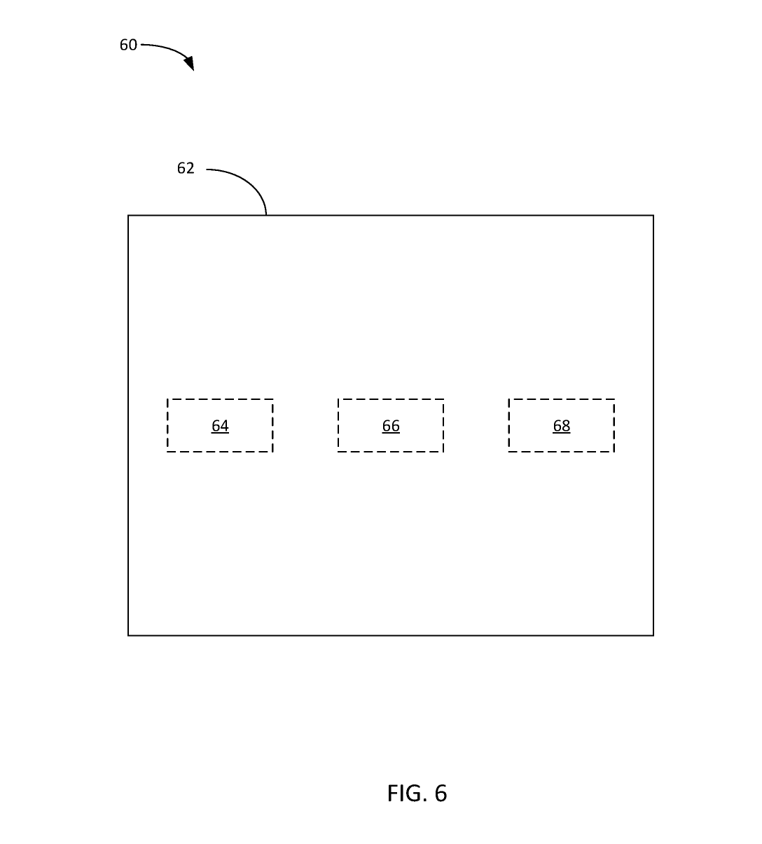

As shown in FIG. 6, stage mode 60 may similarly display multiple content items 64, 66, 68 of a presentation on a display device 62 in concert, such as described above with respect to collage mode and may further automatically (or in response to an input of a user) equally space and/or align a plurality of content items on one or more displays of a presentation system. Stage mode may similarly respond automatically and re-space, orient and/or arrange content items of a presentation in response to one or more content items being added or removed from a presentation.

In a save presentation layout mode, the current layout of a presentation along with its content, once designed, may be saved for later use within the same or another presentation.

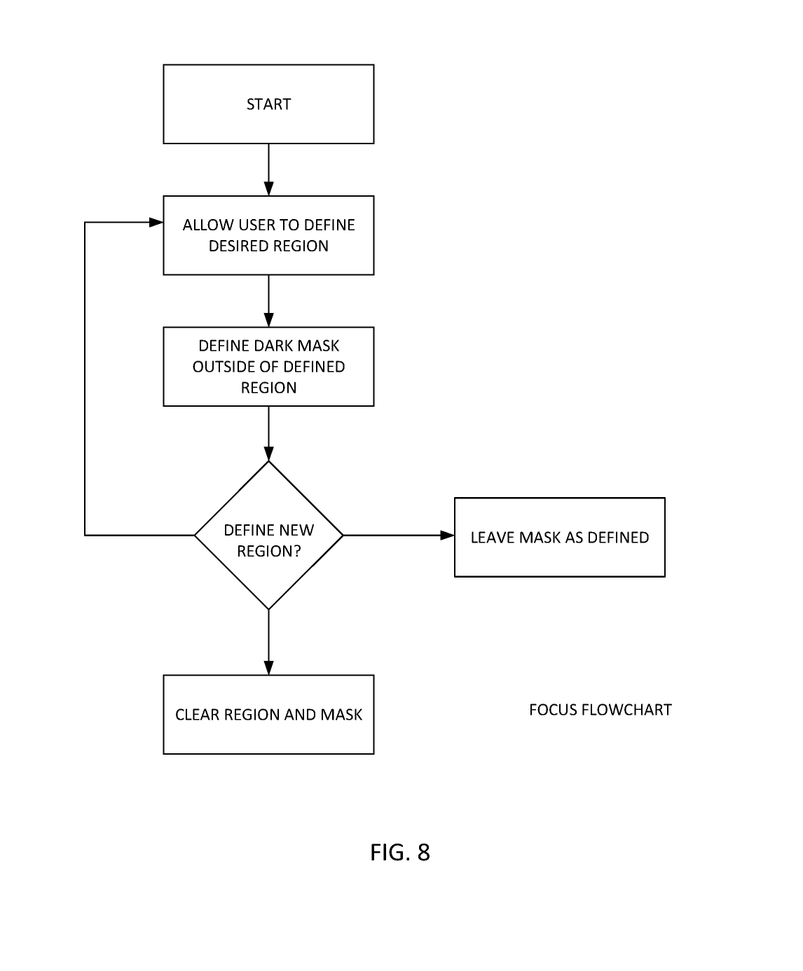

The media presentation system 10 may further include one or more annotation tools for annotating one or more components of a presentation within a presentation mode of the system 10. In one implementation, for example, the media presentation system 10 may include a context-saving crop tool in which a portion of a presentation can be selected and highlighted, while the selected portion is kept in context with respect to the remainder of the presentation display. One example implementation of such a context-saving crop tool is shown in the attached “Focus Flowchart” shown in FIG. 8. In this implementation, the selected portion of the presentation, for example, may be highlighted (e.g., displayed at normal or increased intensity) while the remainder of the presentation display (the non-selected portion) may be shown in a reduced intensity relative to the selected portion. In this manner, the selected portion of the presentation is highlighted, but a viewer is still aware of the surrounding content and the “context” of the selected portion within the overall presentation display. In one particular implementation, for example, the selected portion of the presentation may include all or a portion of a video file that may be displayed within the presentation display. Thus, in one example, a portion of a video file (e.g., a particular area of interest shown in the video) may be highlighted (e.g., shown at a first intensity) and the remaining display of the video file may be de-emphasized (e.g., blacked or grayed out and/or shown at a second intensity less than the first intensity so that the selected portion of the video is highlighted during playback relative to one or more non-selected portions of the video display. In addition, a highlighted portion (e.g., that has been cropped and/or highlighted) can also be enlarged or reduced in size for greater or lesser magnification.

In the example implementation shown in FIG. 8, for example, the control system is adapted to allow a user to define a desired region of a presentation display screen. The control system then defines a relatively darker or less emphasized region outside the defined region (e.g., a dark mask covering the remaining region(s) of the presentation display screen). The control system then continues to monitor for a user input. If the user elects to define a new region, the control system returns to the operation of allowing the user to define a desired region of the presentation display screen. If the user takes no action or elects to maintain the focus region, the control system leaves the regions in the current state (e.g., relative highlight region and remaining de-emphasized region). If the control system receives a response from the user to exit the focus operation, the control system clears the emphasized region, any mask and returns to a standard display mode.

A video annotation tool may also be provided. In one example, the video annotation tool is used to annotate a video used in a presentation display. In one implementation, for example, the annotation may be performed within a presentation mode of the media presentation system. Further, the video file may then be shown with the annotations included. In this particular implementation, the annotation allows for a presentation to be created/modified within a presentation mode so that the creator is able to see the actual presentation files when the presentation is being created.

An object creation tool may also be included within a media presentation system. The object creation tool provides a tool adapted for creating an object that may be inserted within one or more presentations. In implementation, for example, a whiteboard tool may be used to create an object (e.g., file) within a presentation mode of the media presentation system and provide the object for use within the presentation. Again the object creation tool provides a method for a content creator to create/modify an object on the fly within the presentation mode of the system.

A presentation builder tool and/or window (e.g., a back end tool/window) may also be included within the media presentation system. In one implementation, for example, the presentation builder tool allows a user to create and organize a presentation using a file structure, such as folders and subfolders to organize objects available to be used within a presentation. In a trial exhibit presentation, for example, a file structure may be used to organize exhibits for different witnesses in different folders/subfolders (e.g., identified by name, format, color, appearance, images, icons and/or other identifiers). The presentation builder tool may also allow a user to add folders available for constructing the presentation for use on-line (e.g., within a presentation mode) and/or offline outside of a presentation mode (e.g., using a mouse/keyboard or other computer input device). Where the presentation is being built within a presentation mode, the media presentation system allows the user to see the actual presentation being designed during the building process.

In one particular implementation, the presentation builder tool further comprises a queue of content available to be used (e.g., inserted) within a presentation. Content may be selected from the queue for insertion within the presentation and/or removed from the presentation and added back to the queue for possible later use within the presentation. The queue, for example, may include active content (currently used within a presentation), available content (content selected for possible use within the presentation) and/or content removed from the presentation (e.g., recently removed content that may be re-inserted within the presentation.

In one implementation, a presentation builder can also be used to arrange content behind the scene (e.g., outside a presentation mode on a separate computer such as a laptop communicatively coupled to the presentation display device) and then push content into the presentation (e.g., a live presentation) without an audience seeing the new content queued for presentation. In one example, a user in this manner can dynamically create and display new content during a live presentation and feed that content to the interactive display.

Content selected for use within a presentation may be arranged in any format desired by a presentation creator. The content may be placed in the front/background or at any location on a presentation display. In one particular implementation, for example, the content may be arranged automatically, such as using the collage or stage modes described above.

Users may interact with the presentation system in any number of ways. Where a touchscreen display such as described above is used, a user may interact with a number of different gestures or motions described above. Three-dimensional virtual reality type input devices or more standard computer input devices, such as but not limited to a keyboard, mouse, stylus, trackball, touchscreen tablet or the like may also be used to interact with the system 10. Gestures or other inputs, for example, may be used to rotate, scale, move, add, remove, play/pause/speed control (e.g., video/audio), scroll through (e.g., turn pages of a multiple-page document, jump to a location in a document or video or step through frames of video content) content within an active presentation mode of the media presentation system.

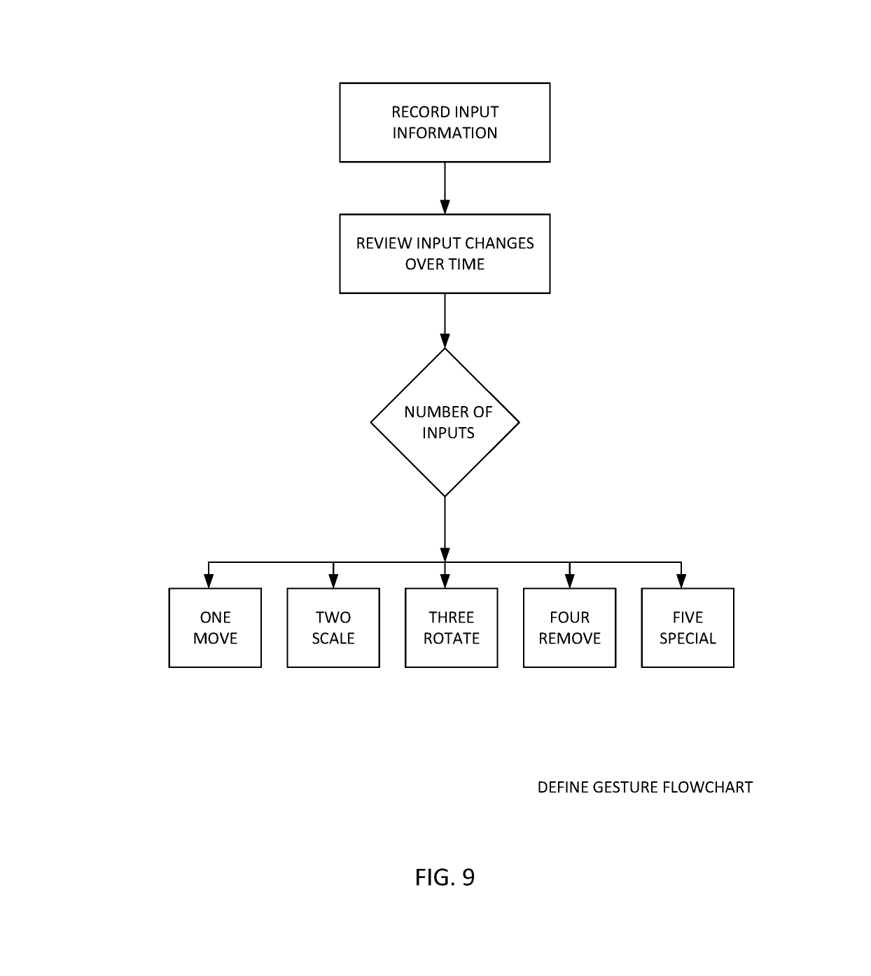

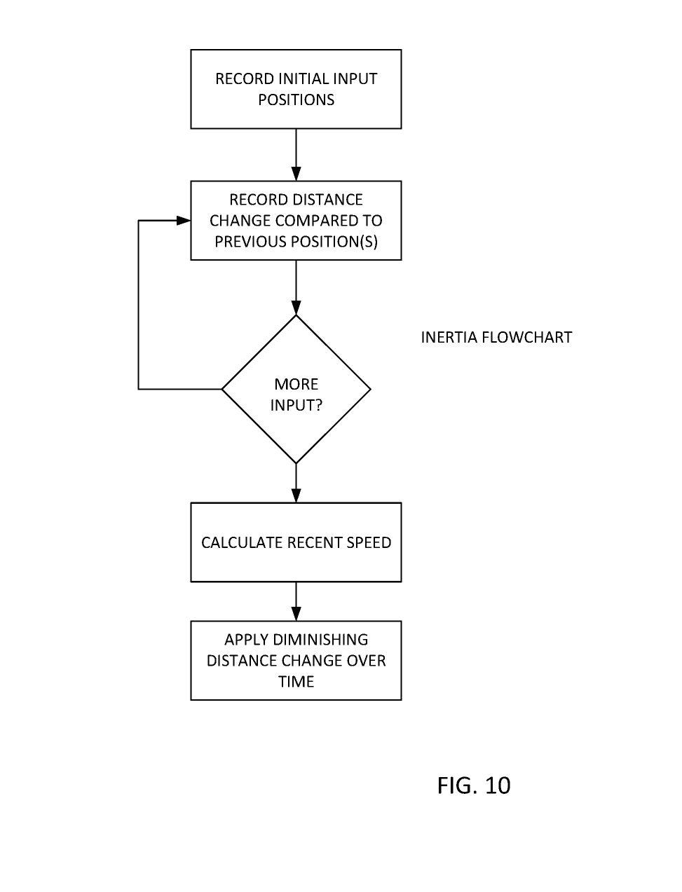

In one particular implementation, for example, user inputs such as gestures, motions and the like may also be able to control movement of content within a presentation mode of a media presentation system, such as shown in the example flowchart of FIG. 9. In this particular example implementation, for example, a control system of a media presentation system is configured to receive one or more inputs to allow a user to make content appear to float or move within the presentation display at a speed related to the input received from the user. A user input device (e.g., a touchscreen, mouse, trackball or the like) may track movement (e.g., fingers moving across a touchscreen input device) by sampling the user's fingers over time and determine a proportional speed to the motion of the user and move one or more content objects within the presentation display at that proportional speed. Where a user is moving or removing an object within or from the presentation display, the control system of the interactive display system may be adapted to sample a user's motion and determine a velocity to move the object within (e.g., across the display) as shown in FIG. 10. Similarly, the system may also determine a deceleration of the object from when the user stops his or her motion and allow the object to continue to move at a decelerating pace until it comes to rest within the presentation display or exits the presentation display and thus removes the content from the presentation display.

A content capture tool (e.g., an image capture tool) may also be used to capture content from an active presentation mode. The captured content, for example, may be saved within a folder structure such as described above for later use within the same or a later presentation.

### Exemplary Computing System

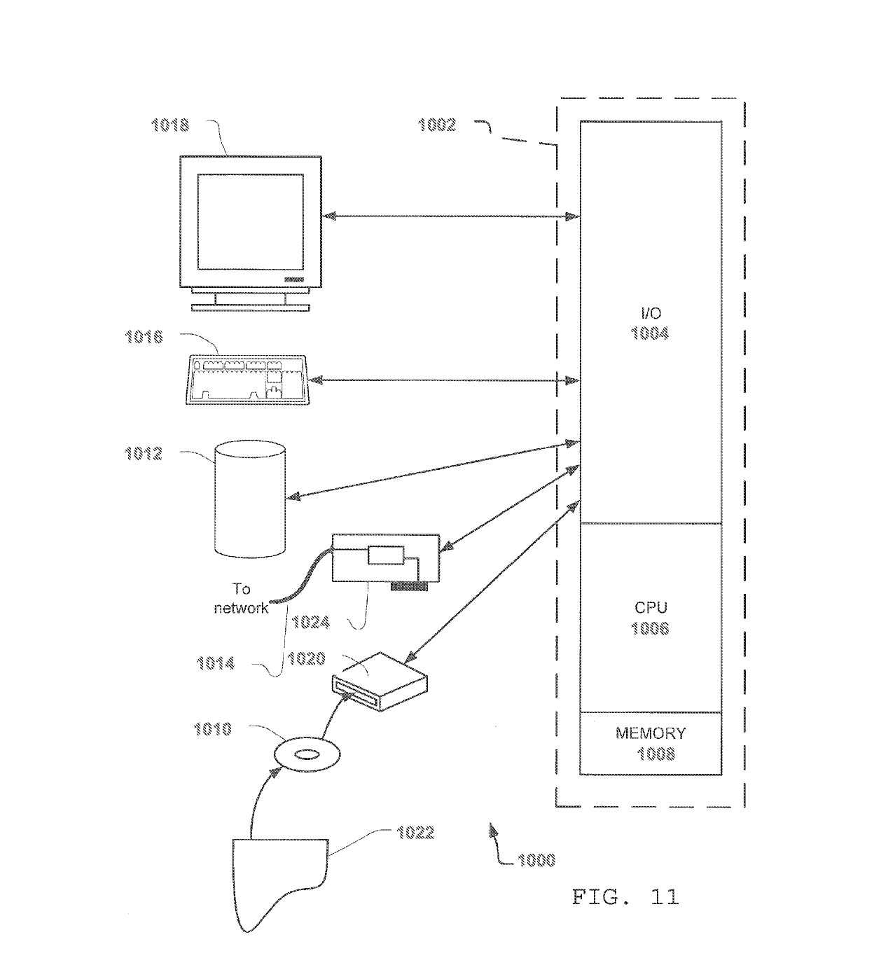

FIG. 11 is a schematic diagram of a computing device 1000 that may be used as a control system (e.g., the control system 16 in FIG. 1) of a media presentation system described herein. As discussed herein, implementations include various steps. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

FIG. 1 illustrates an exemplary system useful in implementations of the described technology. A general purpose computer system 1000 is capable of executing a computer program product to execute a computer process. Data and program files may be input to the computer system 1000, which reads the files and executes the programs therein. Some of the elements of a general purpose computer system 1000 are shown in FIG. 7 wherein a processor 1002 is shown having an input/output (I/O) section 1004, a Central Processing Unit (CPU) 1006, and a memory section 1008. There may be one or more processors 1002, such that the processor 1002 of the computer system 1000 comprises a single central-processing unit 1006, or a plurality of processing units, commonly referred to as a parallel processing environment. The computer system 1000 may be a conventional computer, a distributed computer, or any other type of computer. The described technology is optionally implemented in software devices loaded in memory 1008, stored on a configured DVD/CD-ROM 1010 or storage unit 1012, and/or communicated via a wired or wireless network link 1014 on a carrier signal, thereby transforming the computer system 1000 in FIG. 7 into a special purpose machine for implementing the described operations.

The I/O section 1004 is connected to one or more user-interface devices (e.g., a keyboard 1016 and a display unit 1018), a disk storage unit 1012, and a disk drive unit 1020. Generally, in contemporary systems, the disk drive unit 1020 is a DVD/CD-ROM drive unit capable of reading the DVD/CD-ROM medium 1010, which typically contains programs and data 1022. Computer program products containing mechanisms to effectuate the systems and methods in accordance with the described technology may reside in the memory section 1008, on a disk storage unit 1012, or on the DVD/CD-ROM medium 1010 of such a system 1000. Alternatively, a disk drive unit 1020 may be replaced or supplemented by a floppy drive unit, a tape drive unit, or other storage medium drive unit. The network adapter 1024 is capable of connecting the computer system to a network via the network link 1014, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 1000 is connected (by wired connection or wirelessly) to a local network through the network interface or adapter 1024, which is one type of communications device. When used in a WAN-networking environment, the computer system 1000 typically includes a modem, a network adapter, or any other type of communications device for establishing communications over the wide area network. In a networked environment, program modules depicted relative to the computer system 1000 or portions thereof, may be stored in a remote memory storage device. It is appreciated that the network connections shown are exemplary and other means of and communications devices for establishing a communications link between the computers may be used.

In accordance with an implementation, software instructions and data directed toward operating the subsystems may reside on the disk storage unit 1012, disk drive unit 1020 or other storage medium units coupled to the computer system. Said software instructions may also be executed by CPU 1006.

The implementations described herein are implemented as logical steps in one or more computer systems. The logical operations are implemented (1) as a sequence of processor-implemented steps executing in one or more computer systems and (2) as interconnected machine or circuit modules within one or more computer systems. The implementation is a matter of choice, dependent on the performance requirements of a particular computer system. Accordingly, the logical operations making up the embodiments and/or implementations described herein are referred to variously as operations, steps, objects, or modules. Furthermore, it should be understood that logical operations may be performed in any order, unless explicitly claimed otherwise or a specific order is inherently necessitated by the claim language.

The implementations described herein are implemented as logical steps in one or more computer systems. The logical operations are implemented (1) as a sequence of processor-implemented steps executing in one or more computer systems and (2) as interconnected machine or circuit modules within one or more computer systems. The implementation is a matter of choice, dependent on the performance requirements of the computer system being used. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary implementations of the invention. Since many implementations of the invention can be made without departing from the spirit and scope of the invention, the invention resides in the claims hereinafter appended. Furthermore, structural features of the different implementations may be combined in yet another implementation without departing from the recited claims.

In some implementations, articles of manufacture are provided as computer program products. One implementation of a computer program product provides a non-transitory computer program storage medium readable by a computer system and encoding a computer program.

Furthermore, certain operations in the methods described above must naturally precede others for the described method to function as described. However, the described methods are not limited to the order of operations described if such order sequence does not alter the functionality of the method. That is, it is recognized that some operations may be performed before or after other operations without departing from the scope and spirit of the claims.

Although implementations of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

1. A media presentation system comprising:
a display device comprising a display region;
a user input device; and
a control system,
wherein the control system is configured to modify a presentation while the display device is in a presentation mode.

2. The media presentation system of claim 1 wherein the display device comprises a touchscreen.

3. (canceled)

4. The media presentation system of claim 2 wherein the touchscreen comprises a touchscreen frame mounted to a display device, the touchscreen frame configured to detect one or more gestures.

5. The media presentation system of claim 4 wherein the gestures comprise at least one of the group comprising a single finger touch, a two finger touch, a three finger touch, a four finger touch, a five finger touch, a single finger motion, a two finger motion, a three finger motion, a four finger motion and a five finger motion.

6. The media presentation system of claim 1 wherein the presentation mode comprises one or more of a cinema mode, blackout mode, collage mode, stage mode, presentation mode and save presentation layout mode.

7. The media presentation system of claim 1 wherein the presentation mode comprises a focus mode.

8. The media presentation system of claim 7 wherein a control system of the presentation mode is configured to receive in input from a user identifying a first region of a display region of the interactive display device and display the first region at a first intensity level greater than a second intensity level corresponding to a second region of the display region.

9. The media presentation system of claim 7 wherein a control system of the presentation mode is configured to receive in input from a user identifying a first region of a display region of the display device and display the first region at a first intensity level greater than a second intensity level corresponding to a remainder of the display region.

10. The media presentation system of claim 9 wherein the remainder of the display region is blacked out.

11. The media presentation system of claim 9 wherein the first region is highlighted.

12. The media presentation system of claim 7 wherein the first region comprises at least one media type.

13. The media presentation system of claim 1 wherein the control system is adapted to modify the presentation while the display device is in the presentation mode and then push the modified presentation to the display device.

14. The media presentation system of claim 13 wherein the control system is adapted to modify the presentation via a back end presentation builder interface.

15. The media presentation system of claim 1 wherein the control system is adapted to determine at least one of a speed and an acceleration of a user's motion received via the user input device.

16. An interactive presentation system comprising:
an interactive display device comprising a display region;
a user input device; and
a control system,
wherein the control system is configured to modify a presentation while the display device is in a presentation mode.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A method of controlling a media presentation system comprising:
providing a presentation on a display device in a presentation mode of the media presentation system;
receiving a user input from a user input device of a media presentation system at a control system; and
altering a display in a display region of the display device in response to the user input,
wherein the operation of altering the display comprises modifying the display of the presentation while the media presentation system is in the presentation mode.

32. (canceled)

33. (canceled)

34. (canceled)

35. (canceled)

36. The method of claim 31 wherein the presentation mode comprises one or more of a cinema mode, blackout mode, collage mode, stage mode, presentation mode and save presentation layout mode.

37. The method of claim 31 wherein the presentation mode comprises a focus mode.

38. The method of claim 37 wherein a control system of the presentation mode is configured to receive in input from a user identifying a first region of a display region of the interactive display device and display the first region at a first intensity level greater than a second intensity level corresponding to a second region of the display region.

39. The method of claim 37 wherein a control system of the presentation mode is configured to receive in input from a user identifying a first region of a display region of the interactive display device and display the first region at a first intensity level greater than a second intensity level corresponding to a remainder of the display region.

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)
